(19) United States
(12) Patent Application Publication
(10) Pub. No.: US 2021/0158809 A1
(43) Pub. Date: May 27, 2021

(54) EXECUTION OF FUNCTION BASED ON USER BEING WITHIN THRESHOLD DISTANCE TO APPARATUS

(71) Applicant: Lenovo (Singapore) Pte. Ltd., Singapore (SG)

(72) Inventors: Russell Speight VanBlon, Raleigh, NC (US); Robert Norton, Raleigh, NC (US); Scott Wentao Li, Cary, NC (US); Robert J. Kapinos, Durham, NC (US)

(21) Appl. No.: 16/692,499

(22) Filed: Nov. 22, 2019

(51) Int. Cl. G10L 15/22; G06F 3/01

(52) U.S. Cl. CPC G10L 15/22; G10L 2015/227; G06F 3/017; G06F 3/013

(57) ABSTRACT

In one aspect, a device may include at least one processor and storage accessible to the at least one processor. The storage may include instructions executable by the at least one processor to receive input from a user and to determine whether the user is located within a threshold distance to an apparatus. The instructions may also be executable to, based on a determination that the user is located within the threshold distance to the apparatus, execute at least one function based on the input. The input may include audible input and/or gesture input.

### FIELD

The present application relates to technically inventive, non-routine solutions that are necessarily rooted in computer technology and that produce concrete technical improvements.

### BACKGROUND

As recognized herein, audible input and gesture input that a user provides to a device is often not recognized as it should be due to various circumstances. For instance, the device and user may both be located in a noisy environment and the device may not be able to effectively discern audible input provided by the user from among multiple background sounds in the noisy environment. Moreover, the present application recognizes that unintentional input may sometimes be detected by the device. This might occur when, again using the noisy environment example, multiple people are speaking while a device attempts to receive audible input from the user and the device processes audio from another person that was not meant to be provided to the device instead of processing the audible input from the user. There are currently no adequate solutions to the foregoing computer-related, technological problem.

### SUMMARY

Accordingly, in one aspect a device includes at least one processor and storage accessible to the at least one processor. The storage includes instructions executable by the at least one processor to determine whether a user is within a threshold distance to an apparatus and to decline to execute a function in conformance with audible input received from the user based on a determination that the user is not within the threshold distance to the apparatus. The instructions are also executable to execute a function in conformance with audible input received from the user based on a determination that the user is within the threshold distance to the apparatus. In some examples, the instructions may even be executable to ignore audible input received from at least one other source of sound.

Also in some examples, the instructions may be executable to determine whether the user is within the threshold distance to the apparatus based on input from a camera in communication with the at least one processor. For instance, the determination of whether the user is within the threshold distance to the apparatus may be based on a size of the face of the user as identified from the input from the camera. Additionally or alternatively, the instructions may be executable to determine whether the user is within the threshold distance to the apparatus based on input from an infrared proximity sensor in communication with the at least one processor, and/or based on the time of flight of light emitted by a laser.

Additionally, in some implementations the instructions may be executable to identify one or more objects capable of emitting sound based on input from a camera in communication with the at least one processor and to execute beamforming to identify a direction, relative to the apparatus, from which input to a microphone came. The microphone itself may be in communication with the at least one processor. In these implementations, the instructions may then be executable to identify the user as one of the objects capable of emitting sound and as being in the direction to thus execute the function in conformance with the audible input based on a determination that the user in the direction is within the threshold distance to the apparatus. The audible input itself may be established at least in part based on the input to the microphone. In these implementations, the instructions may even be executable to determine whether the user is within the threshold distance to the apparatus based on input from the camera.

Additionally, in some examples the instructions may be executable to receive input from a camera in communication with the at least one processor and to execute eye tracking based on the input from the camera. The instructions may then be executable to, based on the determination that the user is within the threshold distance to the apparatus and based on a determination using the eye tracking that the user is looking at the apparatus, execute the function in conformance with the audible input received from the user.

The function itself may include executing a user command in conformance with the audible input received from the user, and/or selecting an object represented on an electronic display in conformance with the audible input received from the user.

In some examples, the device may include the apparatus. In other examples, the device may be different from the apparatus. For instance, the device may be a server.

In another aspect, a method includes receiving user input and determining whether the user input is received from a user located within a threshold distance to an apparatus. The method also includes, based on determining that the user input is received from the user located within the threshold distance to the apparatus, executing at least one function based on the user input.

The user input may include audible input and/or input of a gesture performed by a portion of an arm of the user.

In another aspect, at least one computer readable storage medium (CRSM) that is not a transitory signal includes instructions executable by at least one processor to receive input from a user. The instructions are also executable to determine whether the user is located within a threshold distance to an apparatus and to, based on a determination that the user is located within the threshold distance to the apparatus, execute at least one function based on the input. The input may include audible input and/or gesture input.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIGS. 3-5 are illustrations of example use cases consistent with present principles;

FIGS. 6 and 7 are flow charts of example algorithms consistent with present principles; and

FIG. 8 shows an example graphical user interface (GUI) for configuring one or more settings of a device consistent with present principles.

### DETAILED DESCRIPTION

The present application discloses devices and methods to filter input to a digital assistant so that only users within a certain proximity and/or region of a space to the device have their input processed. The user input itself may include voice input, gesture input, etc.

For example, suppose a user is at a sit-down dining restaurant table and provides voice input to a digital assistant device sitting on the table to provide a food order. A camera and microphone on the device may be used to identify who is speaking the order to ensure that only people within a threshold distance or radius (e.g., three feet) of the digital assistant device have their speech processed. The device may even use the face of the user as the object to detect distance based on the size of the face.

As another example, suppose a user is at a fast food restaurant's kiosk and provides voice input to the kiosk to order food from the restaurant. The kiosk may be configured to only accept voice and gesture input from users located within two feet of the kiosk's display screen, and the restaurant may have even placed a box on the floor in front of the kiosk for customers to stand in. The box may thus indicate the distance range at which input may be provided to the kiosk. This may prevent other people's verbal orders from outside the box from confusing the digital assistant used by the kiosk to take the order.

There are several ways to implement present principles. For instance, a device may be pre-configured to accept input within a certain zone/area or distance from the device. The device may then use a sensor (e.g., camera) to detect objects/people that can emit sounds and/or have their commands processed. A user may then speak and the device may use beam forming technology to identify the speaker along with using potentially anonymous “face” recognition to know a user is talking. The device may then calculate the distance between itself and the user/speaker using methods such as laser time of flight, face size estimation, etc. to determine whether to process the input from the user. Other implementation details will be discussed further below, such as using eye tracking filtering and infrared time of flight sensors in combination with the foregoing.

Digital assistant may thus be configured to only “hear” people up to “X” feet away so that they do not process input from far-away speakers beyond the threshold distance. In various examples, the actual distance from the user to the device may be detected during or after the user provides the input.

This technology may be used by digital assistants executing on devices at restaurant tables, checkout lines, open-space conference rooms, video game consoles, at-home stand-alone digital assistant devices, etc. Each device owner/user may even be able to adjust the distance threshold for voice and gesture commands to be accepted and processed, though the device's manufacturer may also set the distance threshold.

Prior to delving into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash.. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any general purpose single- or multi-chip processor that can execute logic by means of various lines such as address lines, data lines, and control lines and registers and shift registers. Moreover, any logical blocks, modules, and circuits described herein can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/ or made available in a shareable library.

Logic when implemented in software, can be written in an appropriate language such as but not limited to C# or C++, and can be stored on or transmitted through a computer-readable storage medium (that is not a transitory, propagating signal per se) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

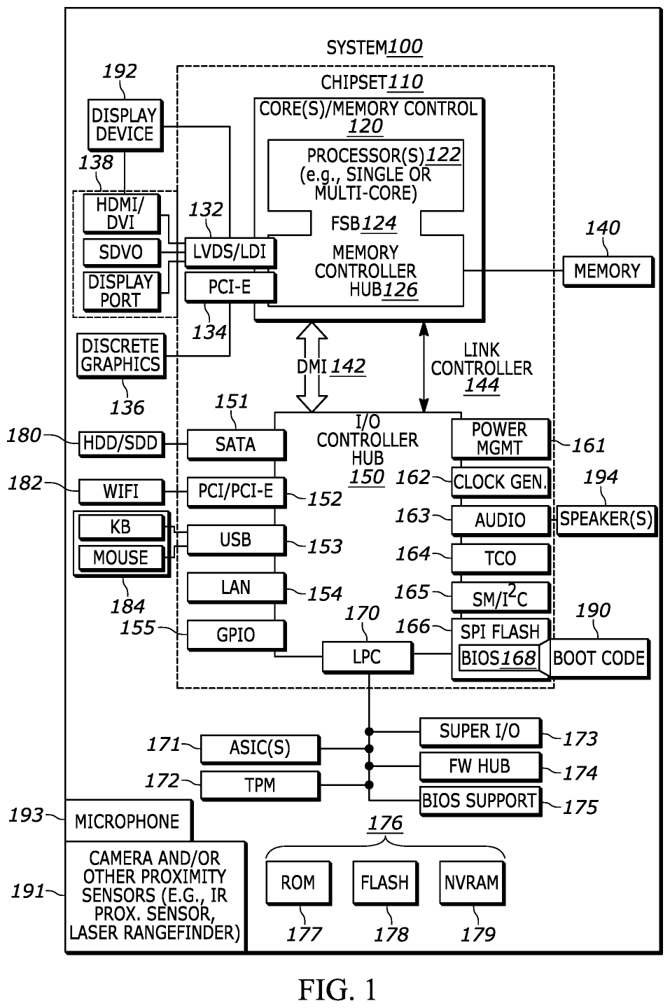

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, the system 100 may include one or more cameras and/or other types of proximity sensors 191. The camera 191 may gather one or more images and provide input related thereto to the processor 122. The camera 191 may be a thermal imaging camera, an infrared (IR) camera, a digital camera such as a webcam, a three-dimensional (3D) camera, and/or a camera otherwise integrated into the system 100 and controllable by the processor 122 to gather pictures/images and/or video. The other proximity sensors 191 may include sensors such as an infrared proximity sensor and/or a laser rangefinder. In implementations where an IR proximity sensor may establish the at least one sensor 191, the IR proximity sensor may include one or more IR light-emitting diodes (LEDs) for emitting IR light as well as one or more photodiodes and/or IR-sensitive cameras for detecting reflections of IR light from the LEDs off of an object proximate to the device. The IR proximity sensor itself and/or the processor(s) 122 may then calculate the time of flight for the IR light to be emitted from the IR LED(s) and reflected back to the photodiodes/cameras to determine distance consistent with present principles.

In implementations where a laser rangefinder may establish the at least one sensor 191, the laser rangefinder may include both a laser for emitting coherent light as well as one or more photodiodes and/or cameras sensitive to the laser light used by the rangefinder (e.g., visible light, IR light, ultraviolet light, etc.) for detecting reflections of the laser light from the laser off of an object proximate to the device. The rangefinder itself and/or the processor(s) 122 may then calculate the time of flight for laser light to be emitted from the laser and reflected back to the photodiodes/cameras to determine distance consistent with present principles.

Still further, the system 100 may include an audio receiver/microphone(s) 193 that may provide input from the microphone 193 to the processor 122 based on audio that is detected, such as via a user providing audible input to the microphone consistent with present principles. In some examples such as where beamforming might be used consistent with present principles, the microphone 193 may actually be an array of plural microphones oriented in different outward directions with respect to the system 100.

Additionally, though not shown for simplicity, in some embodiments the system 100 may include a gyroscope that senses and/or measures the orientation of the system 100 and provides input related thereto to the processor 122, as well as an accelerometer that senses acceleration and/or movement of the system 100 and provides input related thereto to the processor 122. Also, the system 100 may include a GPS transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

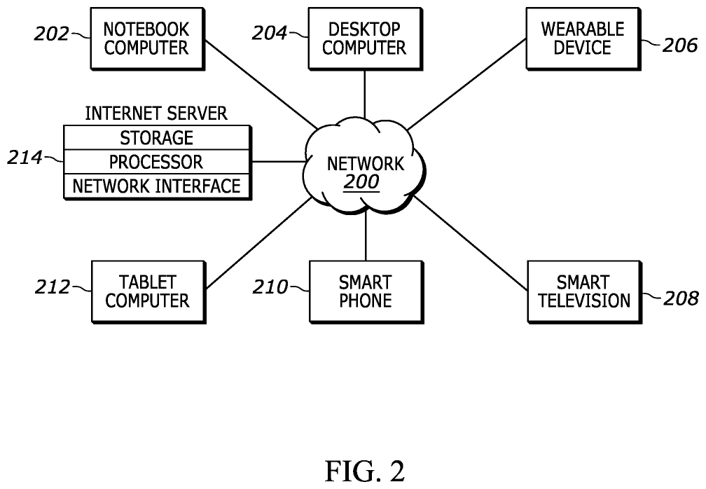

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 are configured to communicate with each other over the network 200 to undertake present principles.

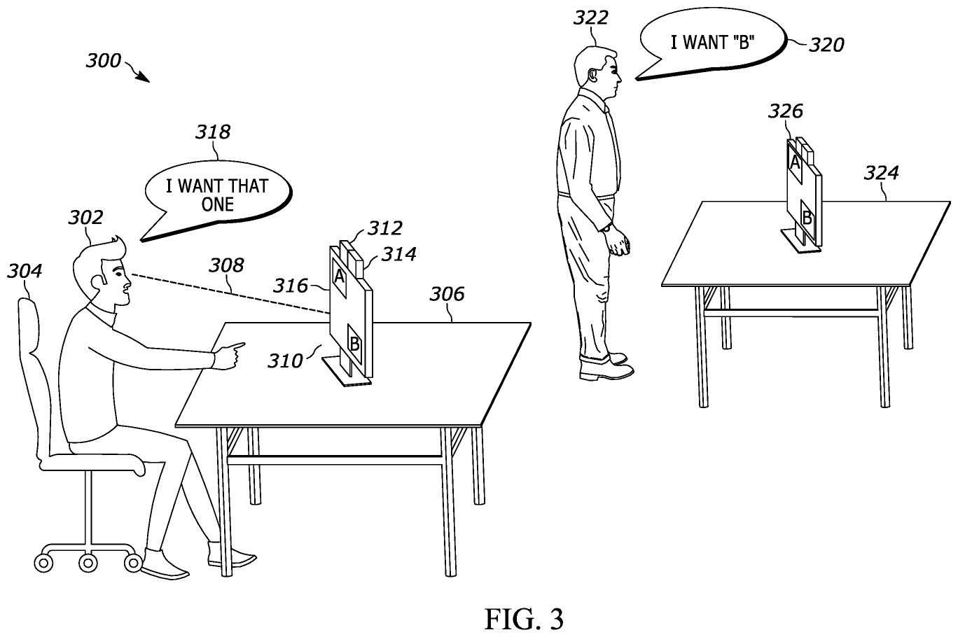

Now in reference to FIG. 3, it shows an illustration of a restaurant 300 consistent with present principles. As shown in FIG. 3, a first user 302 is sitting in a chair 304 at a table 306 in the restaurant with his direction of gaze 308 fixed on a touch-enabled tabletop computer 310. The computer 310 may be established by a laptop computer, a tablet computer, etc., and may include some or all of the components described above with respect to the system 100 such as a camera 312, microphone 314, and touch-enabled display 316.

As shown in FIG. 3, two different selectors “A” and “B” associated with respective food items are being presented on the display 316 while the user 302 speaks audible input 318 indicating “I want that one”, looks at selector “A”, and gestures toward selector “A” with a portion of an arm of the user 302 (in this case, the user's right index finger). After the device 310 uses the microphone 314 to identify the audible input 318 using voice recognition, speech to text processing, and/or a digital assistant such as Google's “Assistant”, Amazon's “Alexa”, or Apple's “Siri”, the device 310 may then perform both eye tracking and gesture recognition using input from the camera 312 to identify the user 302 as both looking at selector “A” and gesturing toward it by pointing toward it with his right index finger. In some examples, the selector that the user 302 is looking at and gesturing toward should both be the same for the device 310 to execute a function associated with that selector in conformance with the audible input 318, while in other examples only one or the other (looking or gesturing toward a particular selector) may suffice to determine the selector referenced by the user 302 for which to execute an associated function.

Regardless, in this case the digital assistant executing at the device 310 has determined that the user 302 is selecting food item “A” in order to provide an electronic notification from the device 310 to another device in the restaurant's kitchen that the user 302 is ordering food item “A” for delivery to the table 306. The device 310 may then determine whether the user 302 is within a threshold distance to the device 310, a prerequisite for the device 310 transmitting the electronic notification in this example. The threshold distance may be three feet, for example. Using input from the camera 312, the device 310 may determine whether the user 302 is actually within the threshold distance (e.g., whether the user's head or right index in particular is within the threshold distance).

For instance, the device 310 may do so using a face size estimation algorithm or application to identify the size of the face of the user 302 as shown in one or more images from the camera 312 to then correlate that size to a distance at which the user 302 is disposed. A relational database stored at the device or elsewhere may be accessed for such purposes, where the database may correlate face sizes/areas with respective distances. The database may even be configured to compensate for the particular focal length of the camera 312.

Additionally or alternatively, the device 310 may use input form the camera 312 as well as spatial analysis software and/or object recognition software to determine the distance from the user 302 to the device 310 to then determine whether the user is within the threshold distance to the device 310. Comparison of the location of the user (e.g., his face) as shown in the images to known locations of other objects that are also shown in the images may thus be used to identify the distance.

In examples where an IR proximity sensor is disposed on the device 310 and used for determining distance consistent with present principles, the IR proximity sensor may include one or more IR light-emitting diodes (LEDs) for emitting IR light as well as one or more photodiodes and/or IR-sensitive cameras for detecting reflections of IR light from the LEDs off of the user's face/finger back to the IR proximity sensor. The time of flight and/or detected intensity of the IR light reflections may then be used to determine the distance from that portion of the user 302 to the device 310. E.g., a relational database may be accessed that correlates IR light reflection times with respective distances.

In examples where laser rangefinder is disposed on the device 310 and used for determining distance consistent with present principles, the laser rangefinder may include one or more lasers for emitting coherent light as well as one or more photodiodes and/or cameras sensitive to the laser light used by the rangefinder (e.g., visible light, IR light, ultraviolet light, etc.) for detecting reflections of the laser light from the laser off of the user's face/finger back to the rangefinder. The time of flight and/or detected intensity of the laser light reflections may then be used to determine the distance from that portion of the user 302 to the device 310. E.g., light detection and ranging (LIDAR) methods for determining distance may be used, as well as a relational database accessible to the device that correlates laser light reflection times with respective distances.

Note that radar transceivers and/or sonar/ultrasound transceivers and associated algorithms/applications may also be used for determining the distance from the user 302 to the device 310 consistent with present principles. Also note that STMicroelectronic's FlightSense Time-of-Flight technology and associated proximity and ranging sensors may be used for determining the distance from the user 302 to the device 310 consistent with present principles.

Regardless of the hardware and methods used, once the device 310 has determined that the actual real-time distance from the user 302 to the device 310 is within the preset threshold distance to the device 310, the device 310 may execute a function in conformance with the audible input 318. In this case, the function is submitting the electronic notification to the restaurant's kitchen that the user is ordering a food item associated with selector “A”. The device may do so even if it also detects, at the same time or a proximate time, audible input 320 from a far-off second user 322 at another table 324 in the restaurant 300 to another device 326 similar to the device 310 to order food item “B”. The device 310 may ignore the audible input 320 based on determining that it did not come from a person within the threshold distance to the device 310 and/or based on determining that it came from a person outside of the threshold distance to the device 310. In this manner, the audible input 318 may be processed while the input 320 may be ignored even if both are detected by the microphone 314, thus enhancing the voice processing capability of the device 310.

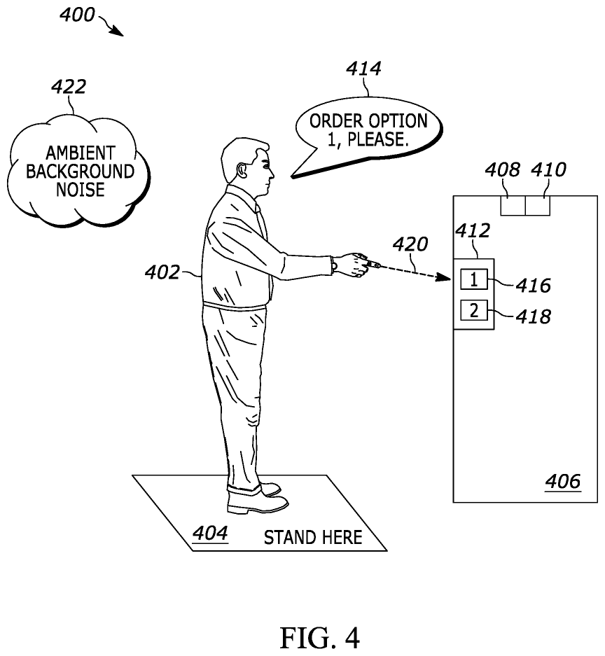

Now in reference to FIG. 4, it shows an illustration of a restaurant 400 consistent with present principles. As shown in FIG. 4, a user 402 is standing within a box 404 painted or etched into the restaurant's floor that encompasses space within a threshold distance from an ordering kiosk 406. The kiosk 406 may include some or all of the components described above in reference to the system 100 of FIG. 1, such as a camera 408, microphone array 410, and touch-enabled display 412. As also shown, the box 404 may include text disposed within and written on the floor, such as “stand here” to indicate that only audible and gesture input provided while standing within the box 404 will be processed by the kiosk 406 owing to the area of the box 404 being within the threshold distance to the kiosk 406 for processing audible and gesture input consistent with present principles.

As the user 402 stands within the box 404, he provides audible input 414 indicating “Order option 1, please” while gesturing with his right index finger to point toward a graphical object 416 representing option 1 without actually touching the area of the display 412 presenting the object 416. In doing so, the user 402 selects “option 1” via the audible and non-touch gesture input, as opposed to selecting other options represented by other objects 418 that are concurrently presented on the display 412.

Then after determining that the user 402 is within the threshold distance to the kiosk 406 using any of the hardware and methods disclosed herein, the kiosk 406 may use input from the camera 408 to detect a direction 420 from the tip of the user's finger to the graphical object 416, and/or use input from the microphone array 410 to detect the audible input 414, to thereby determine that the user is selecting “option 1”. The kiosk 406 may then execute a function in accordance with that input.

For instance, the kiosk 406 may select option 1 for submission of an electronic order by the kiosk 406 to the restaurant's kitchen device for food associated with “option 1” to be prepared and brought up front for pickup by the user 402. Additionally, note that the kiosk 406 may do so despite a significant amount of ambient background noise 422 that might also exist in the restaurant at the time the user provides the audible input 414. This may be accomplished by, for example, executing beamforming using input from the microphone array 410 that indicates the audible input 414 to selectively process the audible input 414 based on its direction of arrival while ignoring other audio such as the noise 422, thus enhancing the voice processing capability of the kiosk 406.

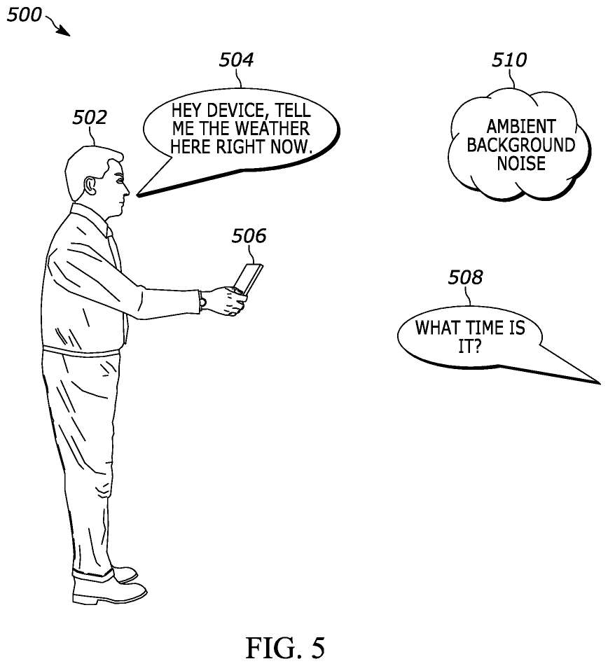

Continuing the detailed description in reference to FIG. 5, it shows an illustration of a user 502 standing in a living room 500 and providing audible input 504 to his smart phone 506. The audible input 504 in this example includes a user command: “Hey device, tell me the weather here right now.” Consistent with present principles, the smart phone 506 may determine that the user 502 is at least within a threshold distance to the smart phone 506 (such as three feet) and then use a digital assistant executing at the smart phone 506 to process the command for weather information at the current location of the user 502. For instance, the smart phone 506 may use camera input to determine that the user 502 is within the threshold distance as well as beamforming to home in on and process microphone input (the audible input 504) from the user 502.

It may be appreciated from the audible input 504 that it includes a trigger or wake-up phrase (“Hey device”) that cues the device that ensuing audible input (“tell me the weather here right now”) will be audible input to the smart phone 506 that is to be processed by the digital assistant on the smart phone 506 to execute a function. Owing to beamforming being used to hone in on the audible input 504 coming from an identified direction of the user 502, other audio 508 that might be uttered by other people and detectable by the microphone array of the smart phone 506 may be ignored to avoid triggering a false positive where the audio 508 would get processed by the smart phone 506 to execute a function that was not intended by the user 502. Note that background noise 510 may also be ignored based on the beamforming.

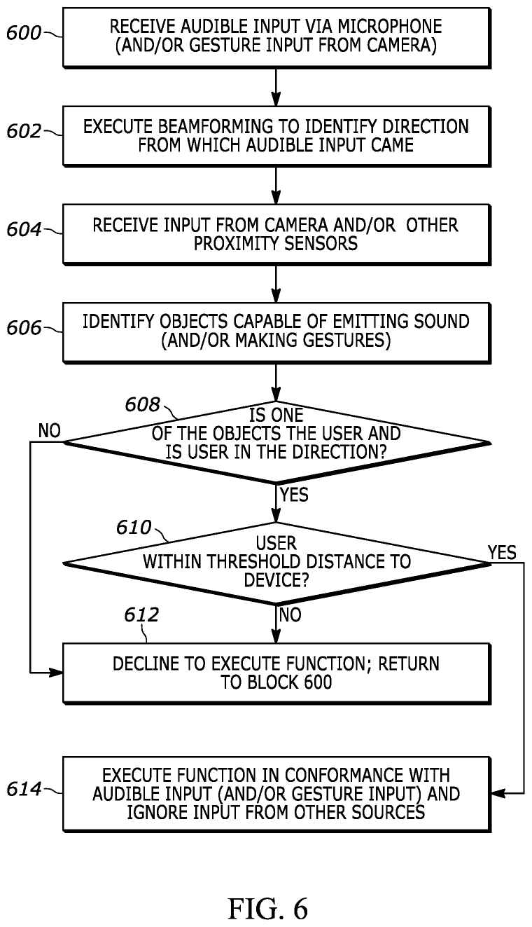

Referring now to FIG. 6, it shows example logic that may be executed by a device in accordance with present principles, such as the system 100, the end-user devices 310, 406, and 506 described above, and/or a server in communication with an end-user device that initially detects audible input. Beginning at block 600, the device may receive audible input via a microphone array on or in communication with the device. Also at block 600, the device may receive gesture input via a camera on or in communication with the device.

From block 600 the logic may then proceed to block 602 where the device may execute a beamforming algorithm or application to identify a direction from which the audible input came based on inputs from the various microphones of the microphone array that are oriented in different directions. After identifying the direction from which the audible input came, the logic may then move to block 604 where the device may receive input from a camera and/or other proximity sensor(s) on or in communication with the device. From block 604 the logic may then proceed to block 606 where the device may execute an object recognition algorithm or application to identify objects capable of emitting sound (and/or capable of making gestures) based on the camera input received at block 604.

From block 606 the logic may then proceed to decision diamond 608. At diamond 608 the device may determine whether one of the objects identified as capable of emitting sound is the user and whether the user is in the direction identified at block 602. An affirmative determination at diamond 608 may cause the logic to proceed to decision diamond 610, while a negative determination may cause the logic to proceed directly to block 612.

At decision diamond 610 the device may determine whether the user is within a threshold distance to the device (or if the logic is executed by a remotely-located server, a threshold distance to an apparatus such as an end-user device in communication with the server). The threshold distance may have been set by the user himself, or by a system administrator or manufacturer of the device. Determining whether the user is within the threshold distance to the device may be performed using any of the hardware and methods described herein, such as using cameras and face size estimation, using a laser and time of flight calculations, etc.

A negative determination at diamond 610 may cause the logic to proceed to block 612. At block 612 the device may decline to execute any function in conformance with the audible input (and/or gesture input) received at block 600, even if the device has identified a potential function to execute from the audible input (and/or gesture input). The logic may then return to block 600 and proceed therefrom.

However, note that should an affirmative determination be made at diamond 610, the logic may instead proceed to block 614. At block 614 the device may use voice recognition to execute a function in conformance with the audible input received at block 600, and/or use gesture recognition to execute a function in conformance with gesture input that might also be received at block 600. Also at block 614, the device may ignore audio from any other sources of sound that might also have been detected by the microphone.

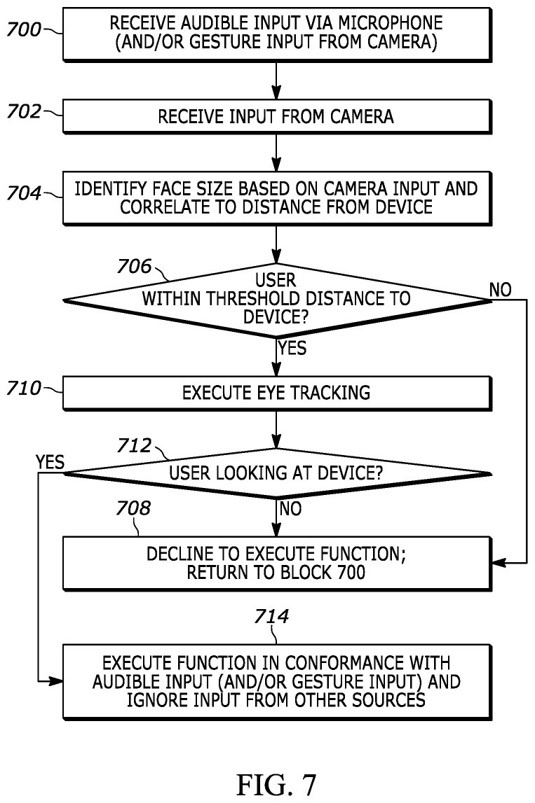

FIG. 7 shows additional logic that may be executed by the same device as FIG. 6. The logic of FIG. 7 may be executed in conjunction with or separate from the logic of FIG. 6. Beginning at block 700, the device may receive audible input via a microphone on or in communication with the device. Also at block 700, in some examples the device may receive gesture input via a camera on or in communication with the device.

If camera input was not already received at block 700 along with the microphone input, and/or if the camera input received at block 700 did not show a user's face, then at block 702 the device may receive input from the camera showing the user's face. The logic may then move to block 704 where the device may identify a face size of the user as appearing in the input (images) from the camera and correlate that face size to a distance the user is estimated to be from the device (or estimated to be from an end-user apparatus if the device executing the logic of FIG. 7 is a remotely-located server). The device may make the correlation, for example, based on data in a relational database that associates respective face sizes/areas with respective distances.

The logic of FIG. 7 may then proceed to decision diamond 706. At diamond 706 the device may determine whether the user is within a threshold distance to the device. The device may do so by comparing the threshold distance to the actual distance from the user to the device that was identified at block 704 to determine whether the actual distance is the same as or less than the threshold distance. A negative determination at diamond 706 may cause the logic to proceed to block 708 where the device may decline to execute any function in conformance with the audible input (and/or gesture input) received at block 700, even if the device has identified a potential function to execute from the audible input. The logic may then return to block 700 and proceed therefrom.

However, note that an affirmative determination at diamond 706 may instead cause the logic to proceed to block 710. At block 710 the device may execute an eye tracking algorithm or application using the images of the user's face to then determine at decision diamond 712 whether the user is or was looking at the device when providing the audible and/or gesture input. A negative determination at diamond 712 may cause the logic to proceed to block 708 as previously described.

However, an affirmative determination at diamond 712 may instead cause the logic to proceed to block 714 since the user being determined to be looking at the device while the audible and/or gesture input was provided may indicate that the user was in fact intending to provide the audible and/or gesture input to the device. At block 714 the device may use voice recognition to execute a function in conformance with the audible input received at block 700 and/or use gesture recognition to execute a function in conformance with gesture input that might also be received at block 700. Also at block 714, the device may ignore audio from any other sources of sound that might also have been detected by the microphone.

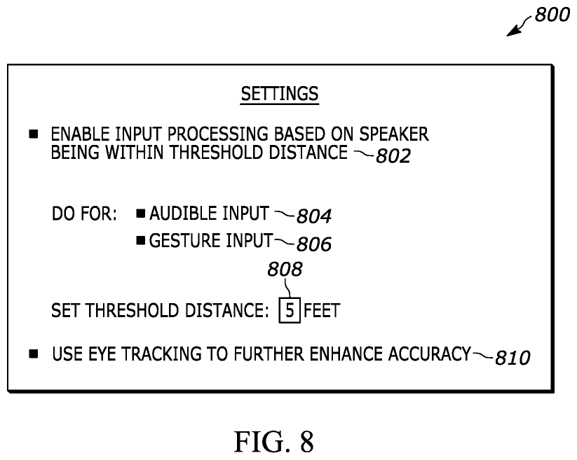

Continuing the detailed description in reference to FIG. 8, it shows an example graphical user interface (GUI) 800 that may be presented on an electronic display to configure settings of a device operating consistent with present principles. For instance, the GUI 800 may be presented on the display of the device itself where the device is, e.g., a smart phone. It is to be understood that each of the options that will be described below may be selected based on selection of the corresponding check box shown adjacent to the respective option.

As shown in FIG. 8, the GUI may include a first option 802 that may be selectable to enable or set the device to perform audible and gesture input processing based on a speaker/person being within a threshold distance to the device. For instance, selection of the option 802 may cause the device to undertake the functions described above in reference to FIGS. 3-5 as well as to execute the logic of FIGS. 6 and 7. In some examples, the GUI 800 may even include options 804 and 806 that may be selectable to respectively enable or set the device to undertake those functions and logic specifically for audible input (option 804) or for gesture input (option 806) if, for instance, the user desires that those functions and logic not be undertaken for both types of input via selection of the option 802.

The GUI 800 may further include a text/number entry box 808 at which the user may provide input specifying the threshold distance for the device to use consistent with present principles. In this example, a user has provided input to the box 808 to establish the threshold distance as five feet.

As also shown in FIG. 8, in some implementations the GUI 800 may further include an option 810 that may be selectable to enable the device to use eye tracking to determine whether the user is looking at the device while providing audible and/or gesture input consistent with present principles to further enhance the accuracy of the device in deciphering input to the device from other audio and gestures that were not intended to be provided as input to the device. For instance, the option 810 may be selected to enable or set the device to undertake the functions of FIG. 7 with respect to block 710 and diamond 712 as described above.

It may now be appreciated that present principles provide for an improved computer-based user interface that improves the functionality and ease of use of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A device, comprising:
at least one processor; and
storage accessible to the at least one processor and comprising instructions executable by the at least one processor to:
determine whether a user is within a threshold distance to an apparatus;
based on a determination that the user is not within the threshold distance to the apparatus, decline to execute a function in conformance with audible input received from the user; and
based on a determination that the user is within the threshold distance to the apparatus, execute a function in conformance with audible input received from the user.

2. The device of claim 1, wherein the instructions are executable to:
determine whether the user is within the threshold distance to the apparatus based on input from a camera in communication with the at least one processor.

3. The device of claim 2, wherein the determination of whether the user is within the threshold distance to the apparatus is based on a size of the face of the user as identified from the input from the camera.

4. The device of claim 1, wherein the instructions are executable to:
identify one or more objects capable of emitting sound based on input from a camera in communication with the at least one processor;
execute beamforming to identify a direction, relative to the apparatus, from which input to a microphone came, the microphone being in communication with the at least one processor;
identify the user as one of the one or more objects capable of emitting sound and as being in the direction; and
based on a determination that the user in the direction is within the threshold distance to the apparatus, execute the function in conformance with the audible input received from the user, the audible input established at least in part based on the input to the microphone.

5. The device of claim 4, wherein the instructions are executable to:
determine whether the user is within the threshold distance to the apparatus based on input from the camera.

6. The device of claim 1, wherein the instructions are executable by the at least one processor to:
determine whether the user is within the threshold distance to the apparatus based on input from an infrared proximity sensor in communication with the at least one processor.

7. The device of claim 1, wherein the instructions are executable by the at least one processor to:
determine whether the user is within the threshold distance to the apparatus based on the time of flight of light emitted by a laser.

8. The device of claim 1, wherein the instructions are executable to:
receive input from a camera in communication with the at least one processor;
execute eye tracking based on the input from the camera; and
based on the determination that the user is within the threshold distance to the apparatus and based on a determination using the eye tracking that the user is looking at the apparatus, execute the function in conformance with the audible input received from the user.

9. The device of claim 1, wherein the instructions are executable to:
based on a determination that the user is within the threshold distance to the apparatus, execute the function in conformance with the audible input received from the user and ignore audible input received from at least one other source of sound.

10. The device of claim 1, wherein the function comprises executing a user command in conformance with the audible input received from the user.

11. The device of claim 1, wherein the function comprises selecting an object represented on an electronic display in conformance with the audible input received from the user.

12. The device of claim 1, wherein the device comprises the apparatus.

13. The device of claim 1, wherein the device is different from the apparatus.

14. The device of claim 13, wherein the device is a server.

15. A method, comprising:
receiving user input;
determining whether the user input is received from a user located within a threshold distance to an apparatus; and
based on determining that the user input is received from the user located within the threshold distance to the apparatus, executing at least one function based on the user input.

16. The method of claim 15, wherein the user input comprises audible input.

17. The method of claim 15, wherein the user input comprises input of a gesture performed by a portion of an arm of the user.

18. At least one computer readable storage medium (CRSM) that is not a transitory signal, the computer readable storage medium comprising instructions executable by at least one processor to:
receive input from a user;
determine whether the user is located within a threshold distance to an apparatus; and
based on a determination that the user is located within the threshold distance to the apparatus, execute at least one function based on the input.

19. The CRSM of claim 18, wherein the input comprises audible input.

20. The CRSM of claim 18, wherein the input comprises gesture input.
